(19) United States
(12) Patent Application Publication
(10) Pub. No.: US 2026/0276115 A1
(43) Pub. Date: Sep. 17, 2026

(54) AXIAL SWAGED FITTING

(71) Applicant: Jeffery J. Chenoweth, Chardon, OH (US)

(72) Inventor: Jeffery J. Chenoweth, Chardon, OH (US)

(21) Appl. No.: 19/556,291

(22) Filed: Mar. 4, 2026

Related U.S. Application Data
(60) Provisional application No. 63/769,838, filed on Mar. 11, 2025.

(51) Int. Cl. F16L 13/14

(52) U.S. Cl. CPC F16L 13/146

(57) ABSTRACT

An axial swaged fitting for permanently joining to a tube to achieve an elastic strain preload condition is disclosed. The fitting includes an annular body including an annular compression cavity, an annular retainer laterally surrounding at least a portion of the body, and an annular collar laterally surrounding at least a portion of the retainer. The body is configured to laterally surround at least a portion of the tube. The annular retainer includes at least one compression tab extended in an axial direction. The at least one compression tab is shaped to correspond to a shape of the compression cavity. The collar is configured to selectively exert a compression force laterally inward toward the tube, the compression force being operative to urge the at least one compression tab into the compression cavity, bringing the axial swaged fitting into the elastic strain preload condition.

### TECHNICAL FIELD

This disclosure relates to an apparatus and method for use of an axial swaged fitting and, more particularly, to an axial swaged fitting for permanently joining to a tube to achieve an elastic strain preload condition.

### BACKGROUND

Permanent fittings are commonly used for connecting metal tubes, conduits, and pipes to each other for use in a variety of applications, for example for the conveyance of gasses, liquids, or other fluids in the medical, aerospace, automotive or other vehicle, construction, or many other industries. It is desirable for the connection between the tubes and fitting to be secure in order to withstand vibrations and adverse conditions.

### SUMMARY

According to one aspect, an axial swaged fitting for permanently joining to a tube to achieve an elastic strain preload condition is disclosed. The exemplary fitting comprises an annular body including an annular compression cavity, an annular retainer laterally surrounding at least a portion of the body, and an annular collar laterally surrounding at least a portion of the retainer. The body is configured to laterally surround at least a portion of the tube. The annular retainer includes at least one compression tab extended in an axial direction. The at least one compression tab is shaped to correspond to a shape of the compression cavity. The collar is configured to selectively exert a compression force laterally inward toward the tube, the compression force being operative to urge the at least one compression tab into the compression cavity, bringing the axial swaged fitting into the elastic strain preload condition.

According to one aspect, a method of permanently joining an axial swaged fitting to a tube to achieve an elastic strain preload condition is provided. The exemplary method comprises laterally surrounding a portion of the tube with an annular body including a compression cavity; laterally surrounding at least a portion of the body with an annular retainer including at least one compression tab, the at least one compression tab shaped to correspond to a shape of the compression cavity; bringing the body and retainer into at least partial lateral contact; locating the at least one compression tab in the compression cavity; providing an annular collar and bringing the collar into at least partial lateral contact with the retainer; sliding the collar axially along the retainer; with the collar, exerting a compression force laterally inward toward the outer tube surface to maintain the at least one compression tab in the compression cavity; and with the compression force, bringing the axial swaged fitting into the elastic strain preload condition.

### BRIEF DESCRIPTION OF THE DRAWINGS

For a better understanding, reference may be made to the accompanying drawings, in which:

FIG. 1 is a schematic cross-sectional view of an aspect of the present invention;

FIG. 2 is an exploded view of the aspect of FIG. 1;

FIG. 3A is a perspective view of a component of the aspect of FIG. 1;

FIG. 3B is a cross-sectional view of FIG. 3A;

FIG. 4A is a perspective view of another component of the aspect of FIG. 1;

FIG. 4B is a cross-sectional view of FIG. 4A;

FIG. 5A is a perspective view of another component of the aspect of FIG. 1;

FIG. 5B is a cross-sectional view of FIG. 5A; and

FIGS. 6-9 schematically cross-sectionally depict a sequence of installation of the aspect of FIG. 1.

### DETAILED DESCRIPTION

It should, of course, be understood that the description and drawings herein are merely illustrative and that various modifications and changes can be made in the structures disclosed without departing from the present disclosure. Spatially relative terms may be used to describe an element and/or feature's relationship to another element(s) and/or feature(s) as, for example, illustrated in the figures. Further, any term of degree used herein, such as “substantially”, means a reasonable amount of deviation of the modified word is contemplated such that the end result is not significantly changed. For example, such terms can be construed as allowing a deviation of at least 5% of the modified word if this deviation would not negate the meaning of the word the term of degree modifies.

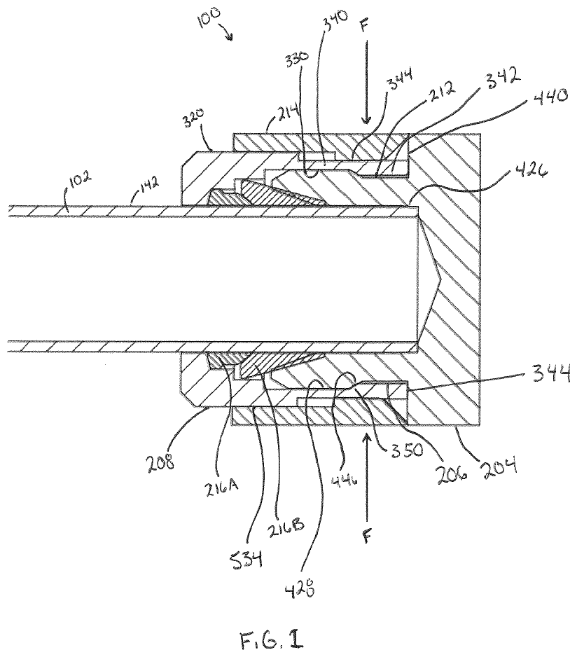

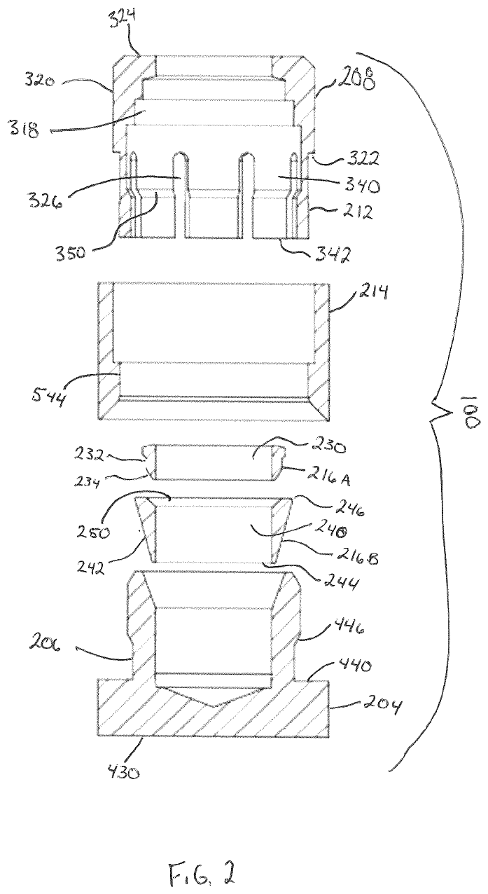

Referring now to the drawings, wherein like numerals refer to like parts throughout the several views, FIG. 1 illustrates an exemplary axial swaged fitting 100 for permanently joining to a tube 102 to achieve an elastic strain preload condition. As shown in the exploded cross-sectional view of FIG. 2, the fitting 100 includes an annular body 204 including a compression cavity 206 (shown here as an annular groove encircling an outer diameter of the body 204). The body 204 laterally surrounds at least a portion of the tube 102, as shown in FIG. 1. The “lateral” direction is substantially parallel to lateral line “La” in FIG. 1. The annular retainer 208 laterally surrounds at least a portion of the body 204. The retainer 208 includes at least one compression tab 212. The at least one compression tab 212 is shaped to correspond to a shape of the compression cavity, and is located in the compression cavity 206, when the fitting 100 is in a use configuration.

An annular collar 214 laterally surrounds at least a portion of the retainer 208. The retainer 208 and/or collar 214 selectively exerts a predetermined compression force (shown schematically as “F”, in FIG. 1) laterally inward toward the tube 102, when the axial swaged fitting 100 is in an assembled, use configuration, to urge the at least one compression tab 212 into the compression cavity 206. It should be appreciated that once the fitting 100 is fully assembled for use, the at least one compression tab 212 may be spaced from a surface of the compression cavity 206 (see FIG. 1) or may contact the surface of the compression cavity and be at least partially deformed into the body 204 via the force F exerted by the retainer 208 and/or collar 214. The term “deform” is used to generally reference all of plastic, elastic, and combination plastic/elastic deformation.

At least one annular ring 216A and/or 216B may be located laterally between the tube 102 and at least one of the body 204 and the retainer 208. (Two rings, 216A and 216B, are shown in the Figures, but will be collectively referenced as “216A and/or 216B” for the sake of this description.) The ring 216A includes inner and outer surfaces 230, 232, with the outer surface 232 at one end portion 234 being ramp shaped. The ring 216B includes inner and outer surfaces 240, 242, and has an increasing thickness from one end 244 to an opposite end 246 such that in cross-section the ring 216B is substantially wedge-shaped. As shown in FIG. 2, an inner surface portion 250 of the inner surface 240 of the ring 216B at the end 246 is flared outwardly. When present, each ring 216A and/or 216B may be deformed into the tube 102 under the predetermined compression force F exerted by the retainer 208 and/or the collar 214. The tube 102 may deform under a laterally oriented force applied by the ring(s) 216A and/or 216B; such “squeezing” compression of a tube 102 during engagement of an axial swaged fitting 100 may assist with sealing the fitting against an outer surface 142 of the tube 102. However, a “squeeze” may be optional during assembly and/or installation of the fitting 100.

As shown in FIG. 1, the body 204, retainer 208, collar 214, ring(s) 216A and/or 216B (when present), and tube 102 may be arranged concentrically around a common longitudinal axis (“Lo”, as depicted). The “longitudinal” direction (or axial direction), as described and used herein, is substantially perpendicular to the lateral direction.

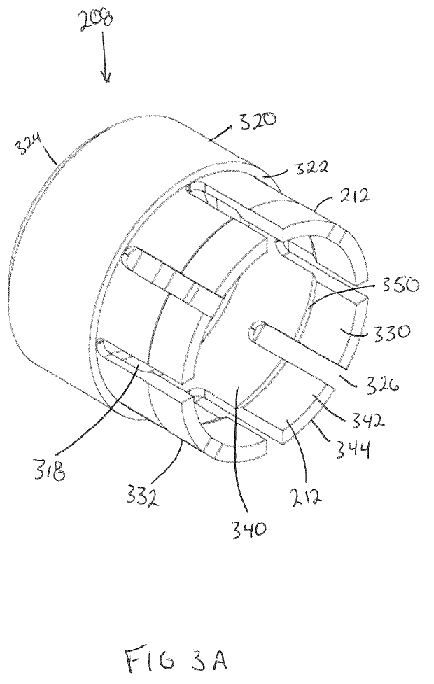

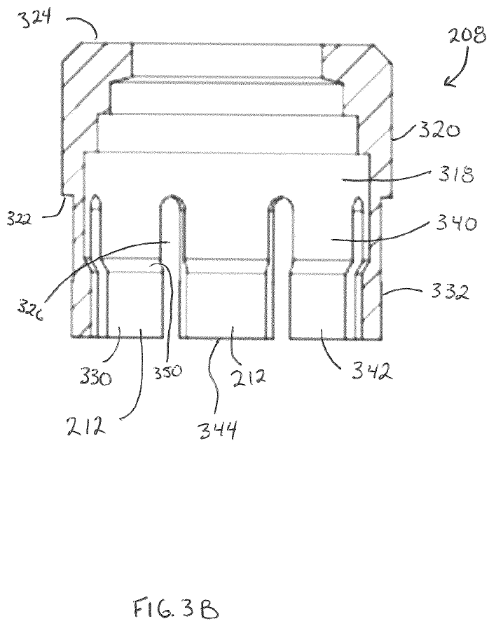

The annual retainer 208 of the axial swaged fitting 100 is shown in perspective view in FIG. 3A and in cross-sectional view in FIG. 3B. The retainer 208 includes laterally spaced, concentrically extending, and oppositely facing inner retainer and outer retainer surfaces 318 and 320, respectively. The retainer 208 may also include longitudinally spaced front and rear retainer rims 322 and 324, respectively. The inner retainer surface 318 may be contoured or stepped, as shown, to interact with other structures of the fitting 100 (e.g., the ring 216A and/or 216B), to assist with manufacturing, or for any desired reason. The at least one compression tab 212 extends in the longitudinal direction from the retainer rim 322, and is integral with the retainer 208 to define a unitary, one piece component of the axial swaged fitting 100. In the depicted aspect, the at least one compression tab 212 is a plurality of radially spaced compression tabs 212. Openings 326 elongated in the longitudinal direction separate each of the compression tabs 212, the openings 326 allowing for movement of the compression tabs 212 in the lateral direction. The present aspect of the retainer 208 includes six compression tabs 212; however, more or less than the six compression tabs are contemplated pending on the application of the axial swaged fitting 100. Each compression tab 212 includes laterally spaced, concentrically extending, and oppositely facing inner tab and outer tab surfaces 330 and 332, respectively. The inner and outer tab surfaces 330, 332 are shaped to maintain the annular, tubular shape of the retainer 208. Each compression tab 212 further includes a first section 340 and a second section 342. The first and second sections 340, 342 are arranged in the longitudinal direction with the first section 340 extended from the retainer rim 322 and the second section 342 extended longitudinally from the first section to a compression tab rim 344. The inner tab surface 330 of each compression tab 212 may be contoured or stepped, as shown, with a lateral thickness of the first section 340 being less than a lateral thickness of the second section 342. The contoured or stepped shape of the inner tab surface 330 is defined by a ramp 350, the ramp serving as a transition between the first and second sections 340, 342.

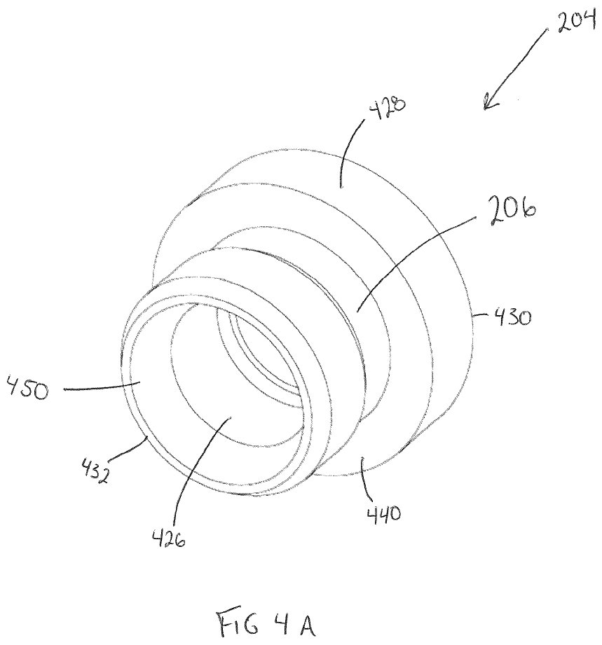

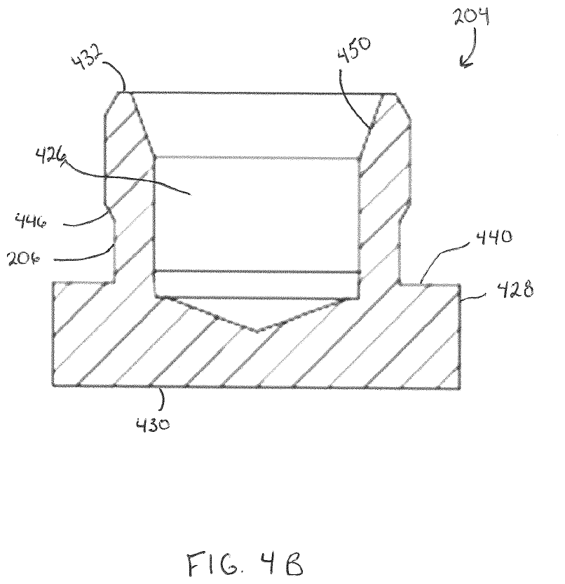

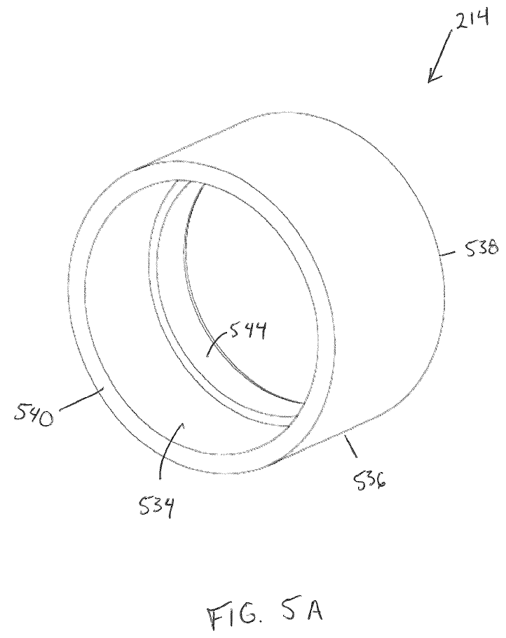

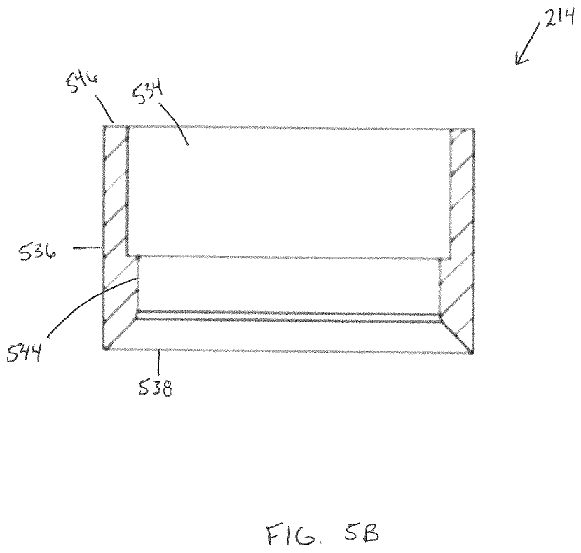

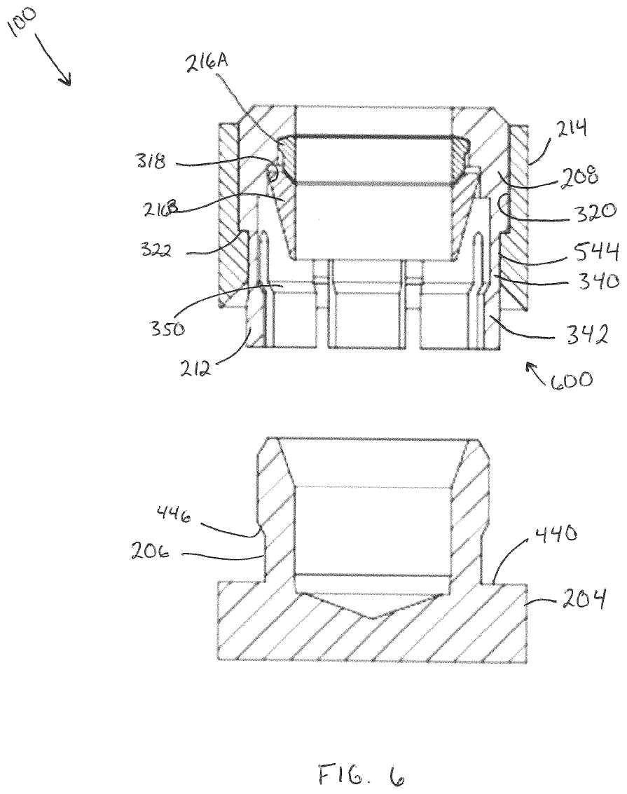

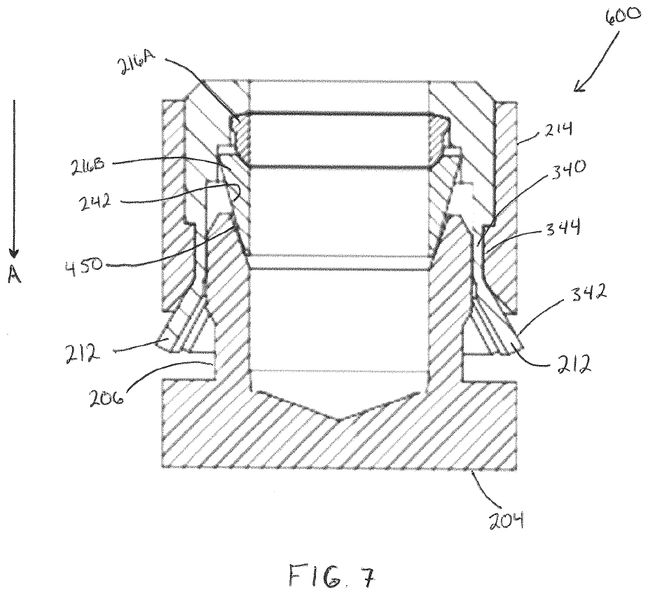

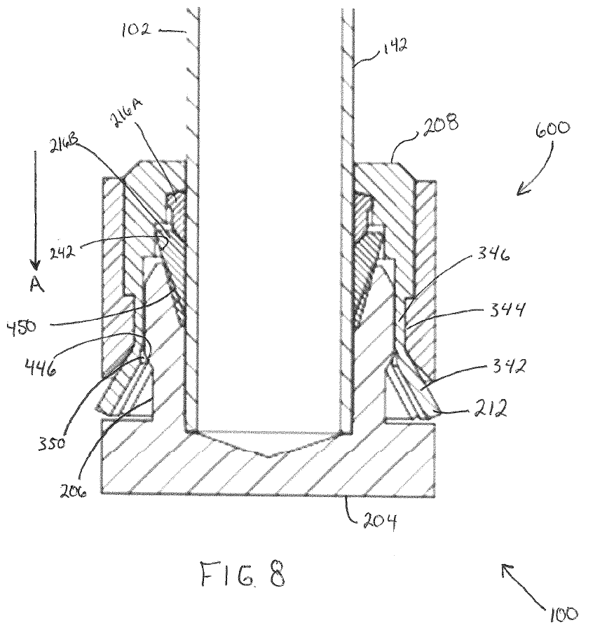

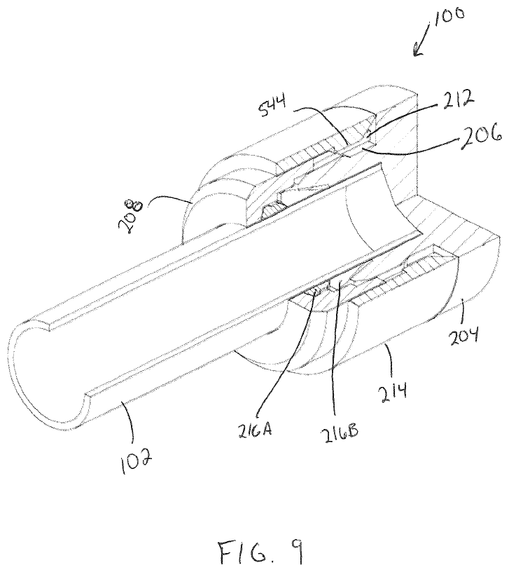

The annular body 204 of the axial swaged fitting 100 is shown in perspective view in FIG. 4A and in cross-sectional view in FIG. 4B. The body 204 includes laterally spaced, concentrically extending, and oppositely facing inner body and outer body surfaces, 426 and 428, respectively. The body 204 may also include longitudinally spaced front and rear body rims 430 and 432, respectively. The inner and/or outer body surfaces 426 and 428 may be contoured or stepped, as shown, to interact with other structures of the axial swaged fitting 100, to assist with manufacturing, or for any desired reason. The front body rim 430 is shown in the Figures as a “blind cap”, for clarity of depiction, but could instead take any desired configuration.

As indicated, the outer body surface 428 includes the compression cavity 206 configured as a single annular groove. The single compression cavity 206 shown may provide manufacturing efficiencies and cost savings over a plurality of individual and smaller body compression cavities (not shown), one for each compression tab 212, though one of ordinary skill in the art could configure the fitting 100 with any number and configuration of compression tabs 212 and corresponding compression cavities 206, or any other features/structures as desired for a particular use environment. A radial wall 440 of the compression cavity 206 serves as an axial stop for the collar 214 (see FIG. 1). The inner body surface 426 includes an outwardly flared inner surface section 450. The outer body surface 428 includes a ramp 446 which serves as a transition into the compression cavity 206.

The collar 214 of the axial swaged fitting 100 is shown in perspective view in FIG. 5A and in cross-sectional view in FIG. 5B. The collar 214 includes laterally spaced, concentrically extending, and oppositely facing inner collar and outer collar surfaces, 534 and 536, respectively. The collar 214 may also include longitudinally spaced front and rear collar rims 538 and 540, respectively. The inner and/or outer collar surfaces 534 and 536 may be contoured or stepped, as shown, to interact with other structures of the fitting 100, to assist with manufacturing, or for any desired reason. In the depicted aspect, the inner collar surface 534 includes a ledge 544 that extends radially inward from the inner collar surface 534. For many use environments of the axial swaged fitting 100, for example, it may be desirable for the components to be relatively configured such that the outer collar surface 536 is substantially flush and contiguous with a laterally outermost portion of the outer body surface 428 of the annular body 204.

With reference back to FIG. 1, when the axial swaged fitting 100 is in an “assembled” or use configuration, the inner collar surface 534 of the collar 214 contacts the outer retainer surface 320 of the annual retainer 208. The inner body surface 426 of the annular body 204 contacts the outer tube surface 142 of the tube 102. The inner tab surface 330 of the first section 340 of each compression tab 212 of the annual retainer 208 contact the outer body surface 428 of the annular body 204. The second section 342 of each compression tab 212 is received in the compression cavity 206, with the ramp 350 contacting the ramp 446. The compression tab rim 344 of each compression tab 212 abuts the radial wall 440. The ledge 544 of the collar 214 is at least partially axially aligned with the second section 342 of each compression tab 212, and is at least partially axially aligned with the abutting ramps 350, 446. The retainer 208 and/or collar 214 selectively exerts the predetermined compression force F laterally inward toward the outer tube surface 142. The predetermined compression force F presses the compression tabs 212 into the body compression cavity 206 of the annular body 204.

As shown in the Figures, it is contemplated that none of the body 204, retainer 208, and collar 214 may include screw threads (to assist with makeup of the axial swaged fitting 100) for many use environments of the fitting 100. As a result, the assembly of the fitting 100 may be done in a purely sliding, such as substantially axially sliding, manner, as will be described below, rather than via a threaded or rotational connection. This lack of screw threads may assist with reducing manufacturing time and costs, and may also be helpful in forming desired swaging relationships using the axial swaged fitting 100 (including components thereof) and the tube 102.

Turning now to the sequence of FIGS. 1 and 6-9, a method of permanently joining an axial swaged fitting 100 to a tube 102 to achieve an elastic strain preload condition will be described. FIG. 6 depicts an early stage in the assembly of the fitting 100, specifically a preassembly of the retainer 208, the collar 214, any desired rings 216A and/or 216B (hereafter the “preassembly 600”). The rings 216A and/or 216B are located on the stepped inner retainer surface 318. The collar 214 is in lateral contact with the retainer 208, with the ledge 544 located on the first sections 340 of the compression tabs 212. The second section 342 of each compression tab 212 extends axially from the collar 214. The collar 214 is fitted onto the retainer 208 by sliding the collar 214 axially along the retainer 208, and more specifically, by sliding the collar 214 axially along the outer retainer surface 320. The ledge 544 abuts the retainer rim 322. This preassembly 600, when it occurs, may be done at any desired point during the manufacture and assembly of the axial swaged fitting 100 and is shown here for clarity. With reference back to FIG. 1, at least one annular ring 216A and/or 216B may be placed laterally between the tube 102 and at least one of the body 204 and the annular retainer 208.

As shown in FIG. 7, the body 204 and retainer 208 are brought into at least partial lateral contact such as by sliding the preassembly 600 axially (in direction “A”) over the body 204. Alternatively, the body 204 can be slid axially into the preassembly 600 (in an opposite direction of direction “A”). The inner surface portion 250 of the ring 216B engages the ramp shaped end portion 234 of the ring 216A. The inner surface portion 450 of the body 204 is slid at least partially along the outer surface 242 of the ring 216B. Therefore, the body 204 engages the rings 216A and/or 216B to maintain their position within the retainer 208. As indicated, the second section 342 of each compression tab 212 has a lateral thickness greater than a lateral thickness of each first section 340. With this configuration, as the preassembly 600 is slid at least partially over the end portion of the body 204, the second sections 342 of the compression tabs 212 are flared radially outwardly by the body 204. The second sections 342 are also axially spaced from the radial wall 440. When the axial swaged fitting 100 achieves the configuration shown in FIG. 7, there may be some degree of laterally inward compressive force present which serves to help maintain the components in the depicted position. This “pre-loading” or “pre-swaging” may be done, for example, at a manufacturing facility (optionally without a tube 102) in order to provide an easily transported one-piece, partially engaged fitting 100. Alternatively, the entire assembly of the fitting 100 into a use condition could be done wholly in the field or in a manufacturing facility, depending upon the use environment.

Turning now to FIG. 8, at least a portion of the tube 102 is laterally surrounded with the annular body 204. This occurs concurrently, in the assembly, with at least a portion of the tube 102 being laterally surrounded with the retainer 208 and collar 214. The end portion of the body 204 further engages the rings 216A and/or 216B, with the inner surface portion 450 of the body 204 being axially slid further along the outer surface 242 of the ring 216B, at least partially deforming the rings 216A and/or 216B inward to create a leak tight interference between the tube 102 and the body 204. The second sections 342 of the compression tabs 212 that are still radially flared by the body 204 are axially located over the compression cavity 206. With the preassembly 600 being further slid axially (in direction “A”) along the tube 102 toward the radial wall 440 of the body 204 (or alternatively with the body 204 being further slid axially into the preassembly 600), a predetermined compression force begins to be exerted laterally inward toward the outer tube surface 142. This action occurs during the “installation” transition from the preliminary or assembly configuration of FIGS. 6 and 7 and occurs through to the finished or use configuration of FIGS. 1 and 9.

As shown, in the sequence of FIGS. 8 and 1, the collar 214 is slid axially toward the radial wall 440 of the body 204, pushing the flared second section 342 of each compression tab 212 in FIG. 8 into the compression cavity 206 of the annular body 204, with the ramp 350 of each compression tab 212 contacting the ramp 446 of the body 204. The ledge 544 of the collar 214 is seated at least partially on the second section 342 of each compression tab 212 to maintain the compression tabs 212 in the compression cavity 206. The ledge 544 is also at least partially seated over the engagement of the ramps 350 of the compression tabs 212 and the ramp 446 of the body 204. This location of the ledge 544 maintains an interference of the ramps 350 with the ramp 446 which prevents the compression tabs 212 from backing out of the compression cavity 206 and also contributes to the predetermined compression force F shown in FIG. 1.

With the predetermined compression force F, the compression tabs 212 are urged into the compression cavity 206 to achieve the use configuration shown in FIGS. 1 and 9, which can be characterized as “elastic strain preloading”. The ring 216A and/or 216B may be further deformed into the tube 102 during installation of the axial swaged fitting 100 into the use configuration. The compression tabs 212 and other structures of the fitting 100 could be considered to be “pressure welded” into place to lock up the fitting 100 for permanent dwelling in the use configuration.

It is contemplated that the axial swaged fitting 100 could be employed, in some use environments, for interconnecting the tube 102 to at least one other tube. In this manner, the fitting 100 could be used to permanently swage two or more tubes into a straight connection, a tee connection, a plus connection, or in any other desired manner.

It will be appreciated that various of the above-disclosed embodiments and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. An axial swaged fitting for permanently joining to a tube to achieve an elastic strain preload condition, the fitting comprising:
an annular body including an annular compression cavity, the body configured to laterally surround at least a portion of the tube;
an annular retainer laterally surrounding at least a portion of the body, the annular retainer including at least one compression tab extended in an axial direction, the at least one compression tab shaped to correspond to a shape of the compression cavity; and
an annular collar laterally surrounding at least a portion of the retainer;
wherein the collar is configured to selectively exert a compression force laterally inward toward the tube, the compression force being operative to urge the at least one compression tab into the compression cavity, bringing the axial swaged fitting into the elastic strain preload condition.

2. The axial swaged fitting of claim 1, wherein the at least one compression tab includes a plurality of radially spaced compression tabs extending longitudinally from the annular retainer.

3. The axial swaged fitting of claim 1, wherein the at least one compression tab includes a first section extending longitudinally from the annular retainer, and a second section extending longitudinally from the first section to a compression tab rim;
wherein the first and second sections are arranged in the longitudinal direction with a lateral thickness of the first section being less than a lateral thickness of the second section.

4. The axial swaged fitting of claim 3, wherein an inner tab surface of the at least one compression tab is contoured with a ramp serving as a transition between the first and second sections.

5. The axial swaged fitting of claim 1, wherein the annular retainer includes concentrically extending and oppositely facing inner and outer retainer surfaces, wherein the inner retainer surface is contoured to interact with structures of the fitting.

6. The axial swaged fitting of claim 1, wherein the annular body includes concentrically extending and oppositely facing inner and outer body, wherein the inner body surface includes an outwardly flared inner surface section, and the outer body surface includes a ramp serving as a transition into the compression cavity.

7. The axial swaged fitting of claim 1, further including at least one annular ring located laterally between the tube and at least one of the body and the retainer.

8. The axial swaged fitting of claim 1, wherein the annular collar includes concentrically extending and oppositely facing inner and outer collar surfaces, wherein the inner collar surface includes a ledge that extends radially inward from the inner collar surface and is at least partially axially aligned with the at least one compression tab.

9. A method of permanently joining an axial swaged fitting to a tube to achieve an elastic strain preload condition, the method comprising:
laterally surrounding a portion of the tube with an annular body including a compression cavity;
laterally surrounding at least a portion of the body with an annular retainer including at least one compression tab, the at least one compression tab shaped to correspond to a shape of the compression cavity;
bringing the body and retainer into at least partial lateral contact;
locating the at least one compression tab in the compression cavity;
providing an annular collar and bringing the collar into at least partial lateral contact with the retainer;
sliding the collar axially along the retainer;
with the collar, exerting a compression force laterally inward toward the outer tube surface to maintain the at least one compression tab in the compression cavity; and
with the compression force, bringing the axial swaged fitting into the elastic strain preload condition.

10. The method of claim 9, wherein laterally surrounding at least a portion of the body with the annular retainer further includes providing a plurality of radially spaced compression tabs extending longitudinally from the annular retainer.

11. The method of claim 11, wherein each compression tab includes a first section extending longitudinally from the annular retainer, and a second section extending longitudinally from the first section to a compression tab rim.

12. The method of claim 9, further including:
locating at least one annular ring laterally between the tube and at least one of the body and the retainer before bringing the body and retainer into at least partial lateral contact; and
deforming the at least one annular ring into the tube under a compression force exerted by the retainer or the collar.

13. The method of claim 9, wherein sliding the collar axially along the retainer includes:
sliding the collar along an outer retainer surface of the retainer; and
with a ledge extending radially inward from an inner collar surface, maintaining at least partial axial alignment with the at least one compression tab while exerting the compression force.

14. The method of claim 9, wherein exerting the compression force laterally inward toward the outer tube surface includes:
pushing a flared second section of the at least one compression tab into the compression cavity; and
contacting a ramp of the at least one compression tab with a ramp of the body during the pushing.

15. The method of claim 9, wherein bringing the axial swaged fitting into the elastic strain preload condition includes:
deforming the at least one compression tab at least partially into the body via the compression force; and
spacing the at least one compression tab from a surface of the compression cavity or contacting the surface and deforming into the body.

16. The method of claim 9, wherein the method is performed in a substantially axially sliding manner without threaded or rotational connection between components of the axial swaged fitting.

17. The method of claim 9, wherein laterally surrounding a portion of the tube with the annular body includes:
providing the compression cavity configured as a single annular groove encircling an outer diameter of the body; and
aligning a radial wall of the compression cavity to serve as an axial stop for the collar.
